(19) United States
(12) Patent Application Publication
(10) Pub. No.: US 2021/0300376 A1
(43) Pub. Date: Sep. 30, 2021

(54) MOVING BODY CONTROL APPARATUS, MOVING BODY, AND MOVING BODY CONTROL METHOD

(71) Applicant: HONDA MOTOR CO., LTD., TOKYO (JP)

(72) Inventors: Kunimichi HATANO, WAKO-SHI (JP); Tadahiko KANOH, WAKO-SHI (JP); Yuta TAKADA, TOKYO (JP); Tsubasa SHIBAUCHI, TOKYO (JP); Shogo KOBAYASHI, WAKO-SHI (JP)

(21) Appl. No.: 17/215,412

(22) Filed: Mar. 29, 2021

(30) Foreign Application Priority Data
Mar. 30, 2020 (JP) 2020-060013

(51) Int. Cl. B60W 30/18; B60W 40/08; G01C 21/34

(52) U.S. Cl. CPC B60W 30/18163; G01C 21/3484; B60W 40/08

(57) ABSTRACT

A moving body control apparatus includes a vicinity information acquiring section that acquires vicinity information of a moving body; a lane change control section that is capable of performing a first lane change, which is a lane change in which a lane boundary line is crossed once, and a second lane change, which is a lane change in which lane boundary lines are crossed a plurality of times; and a region setting section that sets a first lane change region, which is a region in which the first lane change is permitted, and a second lane change region, which is a region in which the second lane change is permitted, based on the vicinity information. The second lane change region is smaller than the first lane change region, in a range where a distance to a branching position leading to a destination is less than a prescribed distance.

### CROSS-REFERENCE TO RELATED APPLICATION

This application is based upon and claims the benefit of priority from Japanese Patent Application No. 2020-060013 filed on Mar. 30, 2020, the contents of which are incorporated herein by reference.

### BACKGROUND OF THE INVENTION

### Field of the Invention

The present invention relates to a moving body control apparatus, a moving body, and a moving body control method.

### Description of the Related Art

Japanese Laid-Open Patent Publication No. 2016-203745 discloses, when it is judged by a judging section that there is space while a vehicle is waiting, moving the vehicle from a standby position unto this space.

### SUMMARY OF THE INVENTION

However, in Japanese Laid-Open Patent Publication No. 2016-203745, it is not always possible to appropriately perform a lane change.

The present invention has the objective of providing a moving body control apparatus, a moving body, and a moving body control method that make it possible to accurately perform a lane change.

A moving body control apparatus according to one aspect of the present invention includes a vicinity information acquiring section that acquires vicinity information of a moving body; a lane change control section that is capable of performing a first lane change, which is a lane change in which a lane boundary line is crossed once, and a second lane change, which is a lane change in which lane boundary lines are crossed a plurality of times; and a region setting section that sets a first lane change region, which is a region in which the first lane change is permitted, and a second lane change region, which is a region in which the second lane change is permitted, based on the vicinity information, wherein the second lane change region is smaller than the first lane change region, in a range where a distance to a branching position leading to a destination is less than a prescribed distance.

A moving body according to another aspect of the present invention includes the moving body control apparatus such as described above.

A moving body control method according to yet another aspect of the present invention includes a vicinity information acquisition step of acquiring vicinity information of a moving body; and a region setting step of setting a first lane change region in which a first lane change, which is a lane change in which a lane boundary line is crossed once, is permitted, and a second lane change region in which a second lane change, which is a lane change in which lane boundary lines are crossed a plurality of times, is permitted, based on the vicinity information, wherein the second lane change region is smaller than the first lane change region, in a range where a distance to a branching position leading to a destination is less than a threshold value.

According to the present invention, it is possible to provide a moving body control apparatus, a moving body, and a moving body control method that can suitably perform a lane change.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram showing a moving body including a moving body control apparatus according to an embodiment;

FIG. 2 is a diagram showing an example of travel lanes;

FIG. 3 is a diagram showing an example of travel lanes;

FIG. 4 is a flow chart showing an example of an operation of the moving body control apparatus according to an embodiment;

FIG. 5 is a flow chart showing an example of an operation of the moving body control apparatus according to an embodiment; and

FIG. 6 is a flow chart showing an example of an operation of the moving body control apparatus according to an embodiment.

### DESCRIPTION OF THE PREFERRED EMBODIMENTS

Preferred embodiments of a moving body control apparatus, a moving body, and a moving body control method according to the present invention will be presented and described below with reference to the accompanying drawings.

### Embodiment

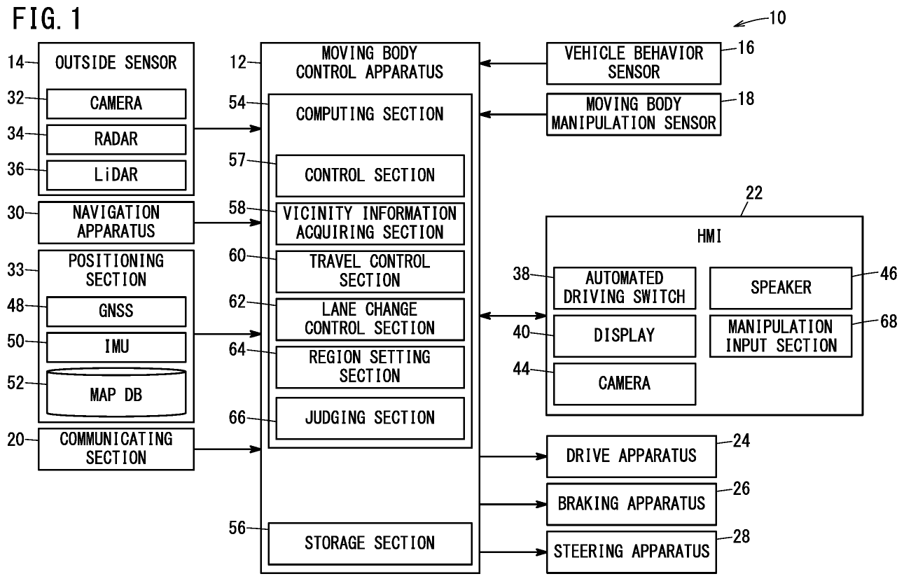

A moving body control apparatus, a moving body, and a moving body control method according to an embodiment will be described using drawings. FIG. 1 is a block diagram showing a moving body that includes a moving body control apparatus according to the present embodiment. Here, an example is described of a case in which the moving body 10 is a vehicle, but the moving body 10 is not limited to being a vehicle. For example, the moving body 10 may be a robot or the like.

The moving body 10 includes a moving body control apparatus 12, i.e. a moving body control ECU (Electronic Control Unit). The moving body 10 further includes an outside sensor 14, a vehicle behavior sensor 16, a moving body manipulation sensor 18, a communicating section 20, and an HMI (Human-Machine Interface) 22. The moving body 10 also includes a drive apparatus 24, a braking apparatus 26, a steering apparatus 28, a navigation apparatus 30, and a positioning section 33. The moving body 10 includes configurational elements other than the above configurational elements, but descriptions thereof are omitted.

The outside sensor 14 acquires outside information, which is information concerning the area around the moving body 10. The outside sensor 14 includes a plurality of cameras 32 and a plurality of radars 34. The outside sensor 14 also includes a plurality of LiDARs (Light Detection And Ranging, Laser Imaging Detection And Ranging) 36.

The information acquired by the cameras (imaging section) 32, i.e. camera information, is supplied from the cameras 32 to the moving body control apparatus 12. The camera information is captured image information, for example. The camera information forms outside information, together with the radar information and LiDAR information described further below. In FIG. 1, only one camera 32 is shown, but a plurality of cameras 32 are actually included.

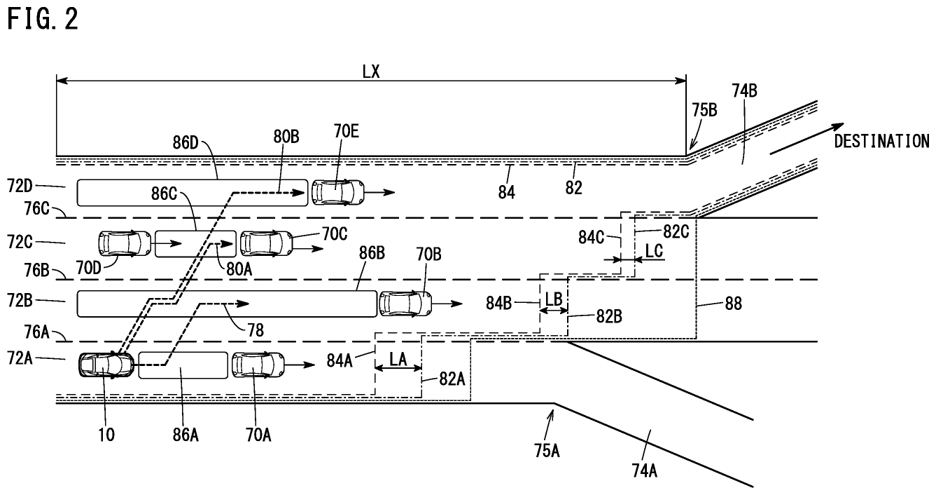

Each radar 34 emits a transmission wave toward the outside of the moving body 10, and receives a reflected wave that comes back to the radar 34 when a portion of the emitted transmission wave is reflected by a detection object. The transmission wave may be an electromagnetic wave or the like, for example. The electromagnetic wave is a millimeter wave or the like, for example. The detection object is another moving body 70A to 70E (see FIG. 2) that is different from the moving body 10, i.e. another vehicle or the like. The radar 34 generates radar information (reflected wave signal) based on the reflected wave or the like. The radar 34 supplies the generated radar information to the moving body control apparatus 12. In FIG. 1, one radar 34 is shown, but a plurality of radars 34 are actually included in the moving body 10. The radars 34 are not limited to being millimeter wave radars. As an example, ultrasonic sensors or the like may be used as the radars 34.

Each LiDAR 36 continuously emits a laser in all directions from the moving body 10, measures the three-dimensional position of a reflection point based on reflected waves resulting from the emitted laser, and outputs information concerning this three-dimensional position, i.e. three-dimensional information. The LiDAR 36 supplies this three-dimensional information, i.e. LiDAR information, to the moving body control apparatus 12. In FIG. 1, one LiDAR 36 is shown, but a plurality of LiDARs 36 are actually included in the moving body 10.

The vehicle behavior sensor 16 acquires information concerning the behavior of the moving body 10, i.e. vehicle behavior information. The vehicle behavior sensor 16 includes a velocity sensor (not shown in the drawings), a wheel velocity sensor (not shown in the drawings), an acceleration sensor (not shown in the drawings), and a yaw rate sensor (not shown in the drawings). The velocity sensor detects the velocity of the moving body 10, i.e. the vehicle velocity. Furthermore, the velocity sensor detects the travel direction (progression direction) of the moving body 10. The wheel velocity sensor detects the velocity of the vehicle wheels (not shown in the drawings), i.e. the wheel velocity. The acceleration sensor detects the acceleration of the moving body 10. The acceleration includes the forward-rear acceleration, the lateral acceleration, and the up-down acceleration. It is acceptable for acceleration in only some of these directions to be detected by the acceleration sensor. The yaw rate sensor detects the yaw rate of the moving body 10.

The moving body manipulation sensor (driving manipulation sensor) 18 acquires information concerning driving manipulations made by an occupant (driver), i.e. driving manipulation information. The moving body manipulation sensor 18 can include an acceleration pedal sensor (not shown in the drawings), a brake pedal sensor (not shown in the drawings), a steering angle sensor (not shown in the drawings), a steering torque sensor (not shown in the drawings), and the like. The acceleration pedal sensor detects the manipulation amount of an acceleration pedal (not shown in the drawings). The brake pedal sensor detects the manipulation amount of a brake pedal (not shown in the drawings). The steering angle sensor detects the steering angle of a steering wheel (not shown in the drawings. The steering torque sensor detects the steering torque applied to the steering torque.

The communicating section 20 performs wireless communication with an external device (not shown in the drawings). The external device can include an external server or the like (not shown in the drawings), for example. The communicating section 20 may be capable or incapable of being attached to and detached from the moving body 10. Examples of a communicating section 20 that is capable of being attached to and detached from the moving body 10 include a mobile telephone, a smartphone, and the like.

The HMI 22 receives the manipulation input made by an occupant, and visually, audibly, or tactilely provides the user with various types of information. The HMI 22 can include an automated driving switch (driving assistance switch) 38, a display 40, a camera 44, a speaker 46, and a manipulation input section 68.

The automated driving switch 38 is a switch with which the occupant issues instructions to start and end automated driving. The automated driving switch 38 includes a start switch (not shown in the drawings) and an end switch (not shown in the drawings). The start switch outputs a start signal to the moving body control apparatus 12, in response to a manipulation by the occupant. The end switch outputs an end signal to the moving body control apparatus 12, in response to a manipulation by the occupant.

The display (display section) 40 includes a liquid crystal display, organic EL display, or the like, for example. Here, an example is described of a case in which the display 40 is a touch panel, but the display 40 is not limited to this.

The camera 44 captures an image of the inside of the moving body 10, i.e. the inside of the vehicle cabin (not shown in the drawings). Furthermore, the camera 44 can be provided to capture an image of the occupant. The camera 44 may be provided on the dashboard (not shown in the drawings) or on the ceiling (not shown in the drawings), for example. The camera 44 outputs information acquired by capturing the image inside the vehicle cabin, i.e. image information, to the moving body control apparatus 12.

The speaker 46 provides the occupant with various types of information using sound. The moving body control apparatus 12 outputs various notifications, warnings, and the like using the speaker 46.

The manipulation input section 68 enables the occupant to perform manipulation input to issue instructions for a lane change. In a case where a lane change proposal is made by the moving body control apparatus 12, the occupant can indicate whether they accept this lane change proposal by using the manipulation input section 68. The manipulation input section 68 is a lever-shaped manipulation element (not shown in the drawings) for example, but is not limited to this. The manipulation input section 68 is provided on a steering column (not shown in the drawings), for example, but is not limited to this. The manipulation input section 68 can pivot clockwise and counter-clockwise centered on a support shaft, for example. The manipulation input section 68 includes a manipulation position sensor (not shown in the drawings). The manipulation position sensor detects a manipulation position of the manipulation input section 68. The manipulation input section 68 supplies information acquired by the manipulation position sensor, i.e. information concerning the manipulation position of the manipulation input section 68, to the moving body control apparatus 12 described further below. The occupant can provide instructions concerning which of a first lane change and a second lane change, described further below, is to be performed, by manipulating the manipulation input section 68. For example, the occupant can issue instructions for the first lane change by rotating the manipulation input section 68 a relatively small amount. Furthermore, the occupant can issue instructions for the second lane change by rotating the manipulation input section 68 a relatively large amount.

The drive apparatus (drive force control system) 24 includes a drive ECU (not shown in the drawings) and a drive source (not shown in the drawings). The drive ECU controls the drive force (torque) of the moving body 10 by controlling the drive source. The drive source can be an engine, a drive motor, or the like, for example. The drive ECU can control the drive force by controlling the drive source, based on manipulation of the acceleration pedal performed by the occupant. Furthermore, the drive ECU can control the drive force by controlling the drive source based on instructions supplied from the moving body control apparatus 12. The drive force of the drive source is transmitted to the vehicle wheels (not shown in the drawings) via a transmission or the like (not shown in the drawings).

The braking apparatus (braking force control system) 26 includes a braking ECU (not shown in the drawings) and a braking mechanism (not shown in the drawings). The braking mechanism causes a braking member to operate using a brake motor, hydraulic mechanism, or the like. The braking ECU can control the braking force by controlling the braking mechanism based on a manipulation of the brake pedal made by the occupant. Furthermore, the braking ECU can control the braking force by controlling the braking mechanism based on instructions supplied from the moving body control apparatus 12.

The steering apparatus (steering system) 28 includes a steering ECU (not shown in the drawings), i.e. an EPS (Electric Power Steering) system ECU, and a steering motor (not shown in the drawings). The steering ECU controls the orientation of the wheels (steered wheels) by controlling the steering motor based on a manipulation of the steering wheel, performed by the occupant. Furthermore, the steering ECU controls the orientation of the wheels by controlling the steering motor based on instructions supplied from the moving body control apparatus 12. The steering may be performed by changing the torque distribution and the braking force distribution among the left and right wheels.

The navigation apparatus 30 includes a GNSS (Global Navigation Satellite System) sensor (not shown in the drawings). Furthermore, the navigation apparatus 30 includes a computing section (not shown in the drawings) and a storage section (not shown in the drawings). The GNSS sensor detects the current position of the moving body 10. The computing section reads map information corresponding to the current position detected by the GNSS sensor, from a map database stored in the storage section. The computing section determines a target route from the current position to a destination, using this map information. The destination is input by the occupant via the HMI 22. As described above, the display 40 is a touch panel. The input of the destination is performed by having the occupant manipulate the touch panel. The navigation apparatus 30 outputs the created target route to the moving body control apparatus 12. The moving body control apparatus 12 supplies this target route to the HMI 22. The HMI 22 displays this target route in the display 40.

The positioning section 33 includes a GNSS 48. The positioning section 33 further includes an IMU (Inertial Measurement Unit) 50 and a map database (map DB) 52. The positioning section 33 identifies the position of the moving body 10 using information acquired by the GNSS 48, information acquired by the IMU 50, and the map information stored in the map database 52. The positioning section 33 can supply the moving body control apparatus 12 with self position information that is information indicating the position of the moving body 10, i.e. position information of the moving body 10. Furthermore, the positioning section 33 can supply the moving body control apparatus 12 with the map information.

The moving body control apparatus 12 includes a computing section 54 and a storage section 56. The computing section 54 performs overall control of the moving body control apparatus 12. The computing section 54 can be formed by one or more processors, for example. A CPU (Central Processing Unit) or the like, for example, can be used as these processors, but the processors are not limited to this. The computing section 54 can perform the control of the moving body 10 by controlling each section based on a program stored in the storage section 56.

The computing section 54 includes a control section 57, a vicinity information acquiring section 58, a travel control section 60, a lane change control section 62, a region setting section 64, and a judging section 66. The control section 57, the vicinity information acquiring section 58, the travel control section 60, the lane change control section 62, the region setting section 64, and the judging section 66 can be realized by having the computing section 54 execute a program stored in the storage section 56.

The storage section 56 includes a volatile memory (not shown in the drawings) and a non-volatile memory (not shown in the drawings). The volatile memory can be a RAM (Random Access Memory) or the like, for example. The non-volatile memory can be a ROM (Read Only Memory), a flash memory, or the like, for example. The outside information, the vehicle behavior information, the driving manipulation information, and the like are stored in the volatile memory, for example. Programs, tables, maps, and the like are stored in the non-volatile memory, for example.

The control section 57 performs overall control of the moving body control apparatus 12.

The vicinity information acquiring section 58 can acquire vicinity information of the moving body 10. This vicinity information can be supplied from the outside sensor 14, for example. The vicinity information may be acquired via the communicating section 20.

The travel control section 60 can control the travel of the moving body 10. More specifically, the travel control section 60 can control the travel of the moving body 10 based on the vicinity information acquired by the vicinity information acquiring section 58. The control of the travel of the moving body 10 can be performed based on information supplied from the navigation apparatus 30.

The lane change control section 62 can control lane changing of the moving body 10. More specifically, the lane change control section 62 can perform an automatic lane change (Auto Lane Changing). The lane change control section 62 can make a lane change proposal to the occupant and perform a lane change if this lane change proposal is accepted by the occupant, but is not limited to this. The lane change control section 62 may automatically perform a lane change without making a lane change proposal to the occupant. Furthermore, a lane change may be performed based on lane change instructions provided by the occupant. When a lane change is to be performed, the lane change control section 62 can provide the occupant with information indicating that the lane change will be performed, using the display 40, the speaker 46, and the like, for example.

FIG. 2 is a diagram showing an example of travel lanes. In the example shown in FIG. 2, a lane 72A, a lane 72B that is adjacent to the lane 72A, a lane 72C that is adjacent to the lane 72B, and a lane 72D that is adjacent to the lane 72C are shown. When describing the lanes in general, the reference numeral 72 is used, and when describing each lane individually, the reference numerals 72A to 72D are used. In the example shown in FIG. 2, the moving body 10 is travelling in the lane 72A, i.e. the user lane. In the example shown in FIG. 2, the lane 72A is connected to a branching lane 74A. The lane 72A branches at a branching position 75A. In the example of FIG. 2, the lane 72D is connected to a branching lane 74B. The branching lane 74B is a lane leading to a destination. The lane 72D branches at a branching position 75B leading to the destination. When describing the branching positions in general, the reference numeral 75 is used, and when describing each branching position individually, the reference numerals 75A and 75B are used. As an example, the portions branching to the branching lanes 74, i.e., the branching portions, correspond to branching positions 75 on a highway or the like. Lane boundary lines 76A to 76C, i.e., lane markers, are provided between the plurality of lanes 72A to 72D. When describing the lane boundary lines in general, the reference numeral 76 is used, and when describing each of the lane boundary lines individually, the reference numerals 76A to 76C are used. In the example shown in FIG. 2, another moving body 70A is travelling in the lane 72A, and this other moving body 70A is positioned ahead of the moving body 10. Furthermore, in the example shown in FIG. 2, another moving body 70B is travelling in the lane 72B, and this other moving body 70B is positioned ahead of the moving body 10. In the example of FIG. 2, other moving bodies 70C and 70D is travelling in the lane 72C. The other moving body 70C is positioned ahead of the moving body 10. The other moving body 70D is positioned behind the other moving body 70C. In the example of FIG. 2, another moving body 70E is travelling in the lane 72D. The other moving body 70E is positioned ahead of the moving body 10. When describing the other moving bodies in general, the reference numeral 70 is used, and when describing each other moving body individually, the reference numerals 70A to 70E are used. Here, an example is described of a case in which the other moving bodies 70 are other vehicles, but the other moving bodies 70 are not limited to this. The other moving bodies 70 may be robots or the like.

The lane change control section 62 can perform the first lane change and the second lane change. The first lane change and the second lane change are both automatic lane changes. The first lane change is a lane change that involves crossing a lane boundary line 76 only once. For example, the first lane change can be a lane change 78 in which the travel lane of the moving body 10 is changed from the lane 72A to the lane 72B. The second lane change is a lane change that involves crossing lane boundary lines 76 a plurality of times. For example, the second lane change can be a lane change 80A in which the travel lane of the moving body 10 is changed from the lane 72A to the lane 72C. In this lane change 80A, after the travel lane of the moving body 10 has been changed from the lane 72A to the lane 72B, the travel lane of the moving body 10 is then quickly changed from the lane 72B to the lane 72C. In other words, in this lane change 80A, a change of the travel lane is performed twice in series. Furthermore, the second lane change can be a lane change 80B in which the travel lane of the moving body 10 is changed from the lane 72A to the lane 72D. In this lane change 80B, after the travel lane of the moving body 10 has been changed from the lane 72A to the lane 72B, the travel lane of the moving body 10 is then quickly changed from the lane 72B to the lane 72C, and then after this, the travel lane of the moving body 10 is changed from the lane 72C to the lane 72D. In other words, in this lane change 80B, a change of the travel lane is performed three times in series.

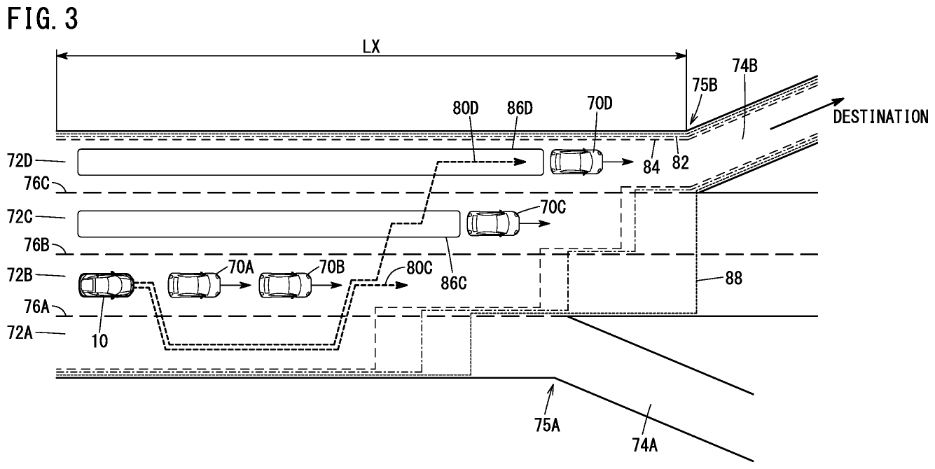

FIG. 3 is a diagram showing an example of travel lanes. In the example shown in FIG. 3, the moving body 10 is travelling in the lane 72B. In the example shown in FIG. 3, other moving bodies 70A and 70B are travelling in the lane 72B, and these moving bodies 70A and 70B are positioned ahead of the moving body 10. In the example shown in FIG. 3, another moving body 70C is travelling in the lane 72C, and this other moving body 70C is positioned ahead of the moving body 10. In the example shown in FIG. 3, another moving body 70D is travelling in the lane 72D, and this other moving body 70D is positioned ahead of the moving body 10. The second lane change can be a lane change 80C in which, after the travel lane of the moving body 10 travelling in the lane 72B has been changed from the lane 72B to the lane 72A, the travel lane is then quickly changed from the lane 72A to the lane 72B. In other words, in this lane change 80C, a change of the travel lane is performed twice in series. The second lane change can also be a lane change 80D in which, after the travel lane of the moving body 10 travelling in the lane 72B has been changed from the lane 72B to the lane 72A, the travel lane is then quickly changed from the lane 72A to the lane 72D. In other words, in this lane change 80D, a change of the travel lane is performed four times in series.

The region setting section 64 sets a first lane change region 82, which is a region in which the first lane change is permitted, and a second lane change region 84, which is a region in which the second lane change is permitted, based on the vicinity information acquired by the vicinity information acquiring section 58. The region setting section 64 can further set a manual lane change region 88, which is a region in which it is possible to perform a lane change manually. The first lane change region 82, the second lane change region 84, and the manual lane change region 88 can be set in a range in which the distance to the branching position 75B leading to the destination is less than a prescribed distance LX, as shown in FIG. 2, for example. As shown in FIG. 2, the second lane change region 84 is smaller than the first lane change region 82. The second lane change region 84 is included in the first lane change region 82. The reason for the second lane change region 84 being smaller than the first lane change region 82 is that the time needed for the second lane change is longer than the time needed for the first lane change. In other words, the reason is that the time needed to comprehend the situation around the moving body 10, generate the movement route of the moving body 10 when performing the lane change, steer the moving body 10, and the like is longer in the case of the second lane change than in the case of the first lane change.

As shown in FIG. 2, end points 82A to 82C of the first lane change region 82 in the travel direction of the moving body 10 are positioned closer to the moving body 10 the greater the distance from the lane 72D connected to the branching lane 74B leading to the destination. That is, the end point 82B, in the travel direction of the moving body 10, of the first lane change region 82 in the lane 72B is positioned closer to the moving body 10 in the travel direction of the moving body 10 than the end point 82C, in the travel direction of the moving body 10, of the first lane change region 82 in the lane 72C. The end point 82A, in the travel direction of the moving body 10, of the first lane change region 82 in the lane 72A is positioned closer to the moving body 10 in the travel direction of the moving body 10 than the end point 82B, in the travel direction of the moving body 10, of the first lane change region 82 in the lane 72B.

As shown in FIG. 2, end points 84A to 84C of the second lane change region 84 in the travel direction of the moving body 10 are positioned closer to the moving body 10 the greater the distance from the lane 72D connected to the branching lane 74B leading to the destination. That is, the end point 84B, in the travel direction of the moving body 10, of the second lane change region 84 in the lane 72B is positioned closer to the moving body 10 in the travel direction of the moving body 10 than the end point 84C, in the travel direction of the moving body 10, of the second lane change region 84 in the lane 72C. The end point 84A, in the travel direction of the moving body 10, of the second lane change region 84 in the lane 72A is positioned closer to the moving body 10 in the travel direction of the moving body 10 than the end point 84B, in the travel direction of the moving body 10, of the second lane change region 84 in the lane 72B.

As shown in FIG. 2, the distance LA between the end point 82A, in the travel direction of the moving body 10, of the first lane change region 82 in the lane 72A and the end point 84A, in the travel direction of the moving body 10, of the second lane change region 84 in the lane 72A is as described below. That is, this distance LA is greater than a distance LB between the end point 82B, in the travel direction of the moving body 10, of the first lane change region 82 in the lane 72B and the end point 84B, in the travel direction of the moving body 10, of the second lane change region 84 in the lane 72B.

Furthermore, as shown in FIG. 2, the distance LB between the end point 82B, in the travel direction of the moving body 10, of the first lane change region 82 in the lane 72B and the end point 84B, in the travel direction of the moving body 10, of the second lane change region 84 in the lane 72B is as described below. That is, this distance LB is greater than a distance LC between the end point 82C, in the travel direction of the moving body 10, of the first lane change region 82 in the lane 72C and the end point 84C, in the travel direction of the moving body 10, of the second lane change region 84 in the lane 72C.

When the occupant of the moving body 10 issues instructions to perform the second lane change in a state where the moving body 10 is positioned inside the first lane change region 82 and outside the second lane change region 84, the lane change control section 62 can perform control such as described below. That is, since the moving body 10 is positioned outside the second lane change region 84, the second lane change cannot be performed. On the other hand, since the moving body 10 is positioned inside the first lane change region 82, the first lane change can be performed. In such a case, the lane change control section 62 performs the first lane change.

The judging section 66 can determine travelled regions 86A to 86D, which are regions that another moving body 70 travelled through less than a prescribed time ago and thereafter has not travelled through (i.e., a prescribed time has not yet elapsed since another moving body travelled through the travelled region). When describing the travelled regions in general, the reference numeral 86 is used, and when describing each individual travelled region, the reference numerals 86A to 86D are used. The lane change control section 62 can generate a travel lane plan according to setting of the destination by the occupant. This travel lane plan is not a plan that indicates a very precise travel path, but is instead a plan that has a certain degree of freedom with regard to a front-rear direction (travel direction of the moving body 10). For example, in the example shown in FIG. 2, a travel lane plan such as shown below can be generated by the lane change control section 62. First, a lane change is performed to position the moving body 10 in the region behind the other moving body 70B. After this, a lane change is performed to position the moving body 10 in the region between the other moving body 70C and the other moving body 70D. After this, a lane change is performed to position the moving body 10 in the region behind the other moving body 70E. In this way, the travel lane plan generated by the lane change control section 62 is a plan that has a certain degree of freedom with regard to the front-rear direction. When the moving body 10 travels through a travelled region 86 according to the travel lane plan, the lane change control section 62 can perform the lane change without acquiring approval for this lane change from the occupant of the moving body 10. This is because, since another moving body 70 has already travelled through this travelled region 86, there is a low possibility of there being an obstacle or the like that would obstruct travel of the moving body 10 in this travelled region 86. When the moving body 10 travels through a region that is not a travelled region 86, the lane change control section 62 can perform a lane change based on the approval of the occupant of the moving body 10. This is because, since it has been a while since another moving body 70 travelled through this region, it is preferable for the occupant to perform a check.

The region setting section 64 may operate to set the first lane change region 82 and the second lane change region 84 only when follow-up travel control is to be performed to follow up another moving body 70 travelling ahead of the moving body 10, but the region setting section 64 is not limited to this.

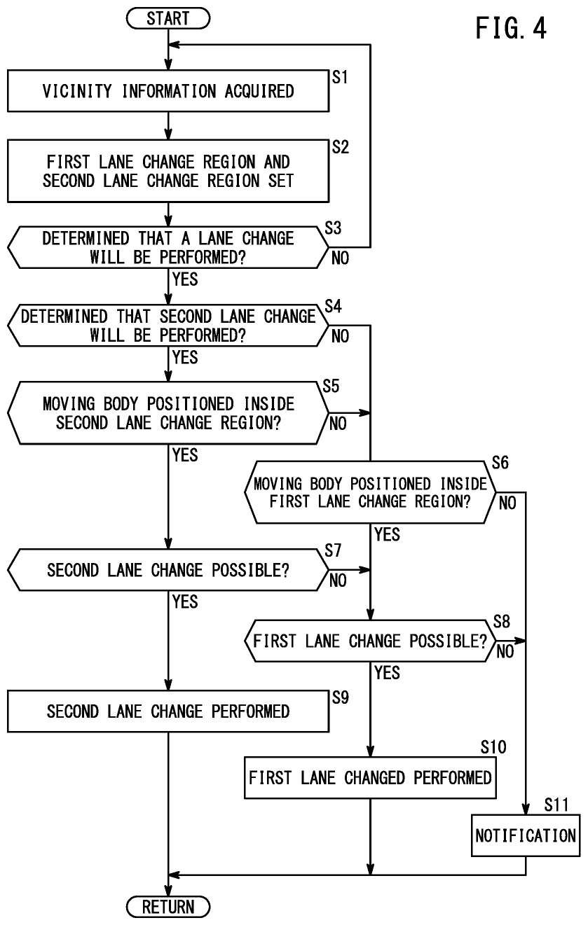

FIG. 4 is a flow chart showing an example of an operation of the moving body control apparatus according to the present embodiment. FIG. 4 shows an example of an operation in a case where the lane change is performed automatically without acquiring approval from the occupant.

At step S1, the vicinity information acquiring section 58 acquires the vicinity information of the moving body 10. After this, the process moves to step S2.

At step S2, the region setting section 64 sets the first lane change region 82 and the second lane change region 84 based on the vicinity information. After this, the process moves to step S3.

At step S3, the lane change control section 62 judges whether the travel control section 60 or the like has determined that a lane change is to be performed. If it has been determined that a lane change is to be performed (YES at step S3), the process moves to step S4. If it has not been determined that a lane change is to be performed (NO at step S3), the processing from step S1 onward is repeated.

At step S4, the lane change control section 62 judges whether the travel control section 60 or the like has determined that the second lane change is to be performed. If it has been determined that the second lane change is to be performed (YES at step S4), the process moves to step S5. If it has been determined that the first lane change is to be performed (NO at step S4), the process moves to step S6.

At step S5, the lane change control section 62 judges whether the moving body 10 is positioned inside the second lane change region 84. If the moving body 10 is positioned inside the second lane change region 84 (YES at step S5), the process moves to step S7. If the moving body 10 is not positioned inside the second lane change region 84 (NO at step S5), the process moves to step S6.

At step S6, the lane change control section 62 judges whether the moving body 10 is inside the first lane change region 82. If the moving body 10 is positioned inside the first lane change region 82 (YES at step S6), the process moves to step S8. If the moving body 10 is not positioned inside the first lane change region 82 (NO at step S6), the process moves to step S11.

At step S7, the lane change control section 62 judges whether the second lane change is possible, based on the vicinity information. If it is judged that the second lane change is possible (YES at step S7), the process moves to step S9. If it is judged that the second lane change is not possible (NO at step S7), the process moves to step S8.

At step S8, the lane change control section 62 judges whether the first lane change is possible, based on the vicinity information. If it is judged that the first lane change is possible (YES at step S8), the process moves to step S10. If it is judged that the first lane change is not possible (NO at step S8), the process moves to step S11.

At step S9, the lane change control section 62 performs the second lane change. When step S9 is completed, the process shown in FIG. 4 ends.

At step S10, the lane change control section 62 performs the first lane change. When step S10 is completed, the process shown in FIG. 4 ends.

At step S11, the control section 57 notifies the occupant about information indicating that an automatic lane change cannot be performed, using the HMI 22. In a case where such notification is provided in a state where the moving body 10 is positioned inside the manual lane change region 88, the occupant can perform a lane change manually, for example. When step S11 is completed, the process shown in FIG. 4 ends.

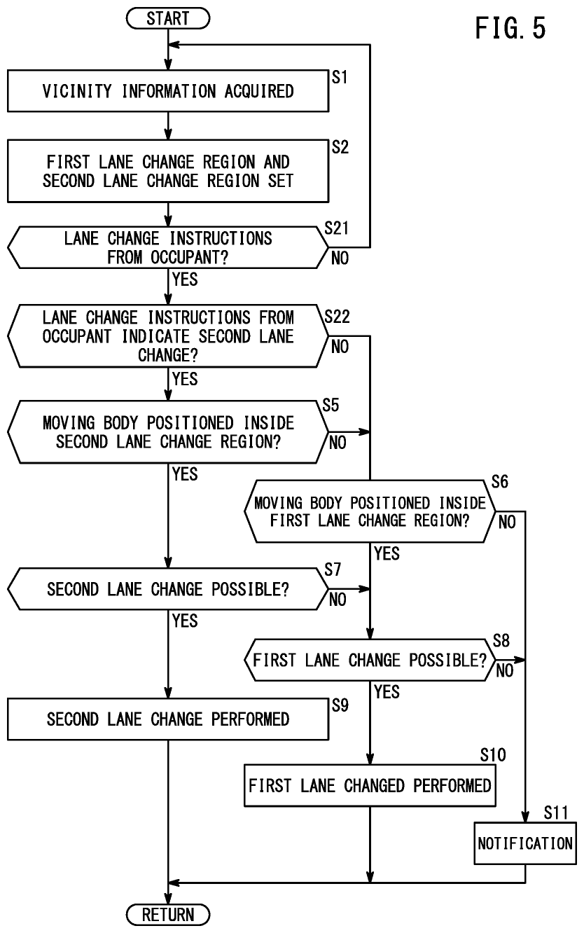

FIG. 5 is a flow chart showing an example of an operation of the moving body control apparatus according to the present embodiment. FIG. 5 shows an example of how the apparatus operates when an automatic lane change is performed based on the occupant's instructions for changing lanes.

Steps S1 and S2 are the same as steps S1 and S2 described above using FIG. 4, and therefore descriptions thereof are omitted.

At step S21, the lane change control section 62 judges whether the occupant has issued instructions for a lane change. These instructions can be issued by the occupant performing a manipulation input via the manipulation input section 68, for example, but are not limited to this. If the occupant has issued instructions for a lane change (YES at step S21), the process moves to step S22. If the occupant has not issued instructions for a lane change (NO at step S21), the processing from S1 onward is repeated.

At step S22, the lane change control section 62 judges whether the lane change for which the occupant issued instructions is the second lane change. If the lane change for which the occupant issued instructions is the second lane change (YES at step S22), the process moves to step S5. If lane change for which the occupant issued instructions is the first lane change (NO at step S22), the process moves to step S6.

Steps S5 to S11 are the same as steps S5 to S11 described above using FIG. 4, and therefore descriptions thereof are omitted. After this, the process shown in FIG. 5 ends.

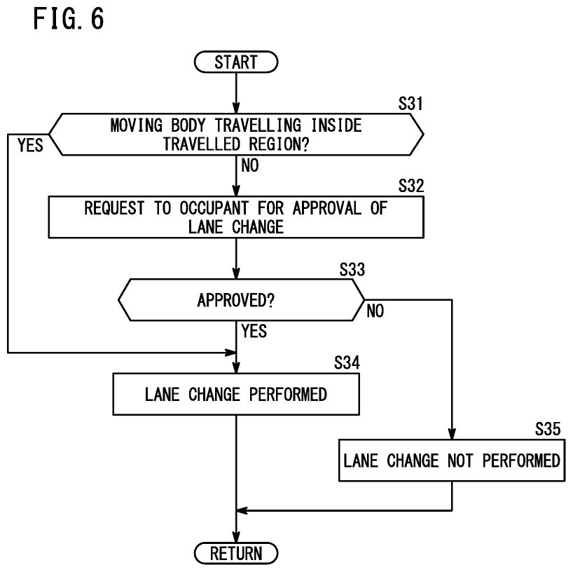

FIG. 6 is a flow chart showing an example of an operation of the moving body control apparatus according to the present embodiment. FIG. 6 shows an example of an operation corresponding to whether the moving body 10 is travelling inside a travelled region 86 according to the travel lane plan.

At step S31, the lane change control section 62 judges whether the moving body 10 is travelling inside a travelled region 86 according to the travel lane plan. If the moving body 10 is travelling inside a travelled region 86 (YES at step S31), the process moves to step S34. If the moving body 10 is travelling outside of a travelled region 86 (NO at step S31), the process moves to step S32.

At step S32, the lane change control section 62 makes a request to the occupant for approval of a lane change. This request can be made via the HMI 22. After this, the process moves to step S33.

At step S33, the lane change control section 62 judges whether the occupant has approved the lane change. This approval can be realized by the occupant performing a manipulation input via the manipulation input section 68, for example, but is not limited to this. If the occupant has approved the lane change (YES at step S33), the process moves to step S34. If the occupant has not approved the lane change (NO at step S33), the process moves to step S35.

At step S34, the lane change control section 62 performs the lane change. When step S34 has been completed, the process shown in FIG. 6 ends.

At step S35, the lane change control section 62 does not perform the lane change. When step S35 has been completed, the process shown in FIG. 6 ends.

In this way, according to the present embodiment, the first lane change region 82, which is a region in which the first lane change is permitted, and the second lane change region 84, which is a region in which the second lane change is permitted, are set based on the vicinity information. The processing for a lane change can be suitably performed based on the first lane change region 82 and the second lane change region 84 set in this manner. Therefore, according to the present embodiment, it is possible to provide the moving body control apparatus 12 that can accurately perform a lane change.

Preferred embodiments of the present invention are described above, but the present invention is not limited to the above-described embodiments, and various alterations can be adopted therein without departing from the scope of the present invention.

The following is a summary of the embodiments described above.

A moving body control apparatus (12) includes a vicinity information acquiring section (58) that acquires vicinity information of a moving body (10); a lane change control section (62) that is capable of performing a first lane change, which is a lane change in which a lane boundary line (76A to 76C) is crossed once, and a second lane change, which is a lane change in which lane boundary lines are crossed a plurality of times; and a region setting section (64) that sets a first lane change region (82), which is a region in which the first lane change is permitted, and a second lane change region (84), which is a region in which the second lane change is permitted, based on the vicinity information, wherein the second lane change region is smaller than the first lane change region, in a range where a distance to a branching position (75B) leading to a destination is less than a prescribed distance (LX). According to such a configuration, the first lane change region, which is a region in which the first lane change is permitted, and the second lane change region, which is a region in which the second lane change is permitted, are set based on the vicinity information. The processing for a lane change can be appropriately performed based on the first lane change region and second lane change region set in this manner. Therefore, according to such a configuration, it is possible to provide the moving body control apparatus that can appropriately perform a lane change.

The second lane change region may be included in the first lane change region.

In a case where a third lane (72B) is positioned between a first lane (72A) in which the moving body is travelling and a second lane (72D) that branches at the branching position, a distance (LA) between an end point (82A), in a travel direction of the moving body, of the first lane change region in the first lane and an end point (84A), in the travel direction of the moving body, of the second lane change region in the first lane may be greater than a distance (LB) between an end point (82B), in the travel direction of the moving body, of the first lane change region in the third lane and an end point (84B), in the travel direction of the moving body, of the second lane change region in the third lane.

If an occupant of the moving body issues instructions to perform the second lane change in a state where the moving body is positioned inside the first lane change region and outside the second lane change region, the lane change control section may perform the first lane change.

The lane change control section may generate a travel lane plan according to setting of a destination by an occupant of the moving body; if the moving body is travelling in a travelled region (86B to 86D) according to the travel lane plan, the lane change control section may perform the lane change without acquiring approval from the occupant, the travelled region being a region which another moving body travelled through less than a prescribed time ago and thereafter has not travelled through; and if the moving body is travelling outside the travelled region, the lane change control section may perform the lane change based on approval from the occupant.

The region setting section may operate to set the first lane change region and the second lane change region only if follow-up travel control to follow up another moving body (70A) travelling ahead of the moving body is to be performed.

The second lane change may include a lane change in which the same lane boundary line (76A to 76C) is crossed a plurality of times.

A moving body includes the moving body control apparatus such as described above.

A moving body control method includes a vicinity information acquisition step (S1) of acquiring vicinity information of a moving body; and a region setting step (S2) of setting a first lane change region in which a first lane change, which is a lane change in which a lane boundary line is crossed once, is permitted, and a second lane change region in which a second lane change, which is a lane change in which lane boundary lines are crossed a plurality of times, is permitted, based on the vicinity information, wherein the second lane change region is smaller than the first lane change region, in a range where a distance to a branching position leading to a destination is less than a threshold value.

What is claimed is:

1. A moving body control apparatus comprising one or more processors that execute computer-executable instructions stored in a memory,
wherein the one or more processors execute the computer-executable instructions to cause the moving body control apparatus to:
acquire vicinity information of a moving body;
perform a first lane change, which is a lane change in which a lane boundary line is crossed once, and a second lane change, which is a lane change in which lane boundary lines are crossed a plurality of times; and
set a first lane change region, which is a region in which the first lane change is permitted, and a second lane change region, which is a region in which the second lane change is permitted, based on the vicinity information, wherein:
the second lane change region is smaller than the first lane change region, in a range where a distance to a branching position leading to a destination is less than a prescribed distance.

2. The moving body control apparatus according to claim 1, wherein:
the second lane change region is included in the first lane change region.

3. The moving body control apparatus according to claim 1, wherein:
in a case where a third lane is positioned between a first lane in which the moving body is travelling and a second lane that branches at the branching position, a distance between an end point, in a travel direction of the moving body, of the first lane change region in the first lane and an end point, in the travel direction of the moving body, of the second lane change region in the first lane is greater than a distance between an end point, in the travel direction of the moving body, of the first lane change region in the third lane and an end point, in the travel direction of the moving body, of the second lane change region in the third lane.

4. The moving body control apparatus according to claim 1, wherein:
if an occupant of the moving body issues instructions to perform the second lane change in a state where the moving body is positioned inside the first lane change region and outside the second lane change region, the one or more processors cause the moving body control apparatus to perform the first lane change.

5. The moving body control apparatus according to claim 1, wherein:
the one or more processors cause the moving body control apparatus to generate a travel lane plan according to setting of a destination by an occupant of the moving body;
if the moving body is travelling in a travelled region according to the travel lane plan, the one or more processors cause the moving body control apparatus to perform the lane change without acquiring approval from the occupant, the travelled region being a region which another moving body travelled through less than a prescribed time ago and thereafter has not travelled through; and
if the moving body is travelling outside the travelled region, the one or more processors cause the moving body control apparatus to perform the lane change based on approval from the occupant.

6. The moving body control apparatus according to claim 1, wherein:
the one or more processors cause the moving body control apparatus to set the first lane change region and the second lane change region only if follow-up travel control to follow up another moving body travelling ahead of the moving body is to be performed.

7. The moving body control apparatus according to claim 1, wherein:
the second lane change includes a lane change in which a same lane boundary line is crossed a plurality of times.

8. A moving body comprising a moving body control apparatus comprising one or more processors that execute computer-executable instructions stored in a memory,
wherein the one or more processors execute the computer-executable instructions to cause the moving body control apparatus to:
acquire vicinity information of a moving body;
perform a first lane change, which is a lane change in which a lane boundary line is crossed once, and a second lane change, which is a lane change in which lane boundary lines are crossed a plurality of times; and
set a first lane change region, which is a region in which the first lane change is permitted, and a second lane change region, which is a region in which the second lane change is permitted, based on the vicinity information, wherein:
the second lane change region is smaller than the first lane change region, in a range where a distance to a branching position leading to a destination is less than a prescribed distance.

9. A moving body control method comprising:
acquiring vicinity information of a moving body; and
setting a first lane change region in which a first lane change, which is a lane change in which a lane boundary line is crossed once, is permitted, and a second lane change region in which a second lane change, which is a lane change in which lane boundary lines are crossed a plurality of times, is permitted, based on the vicinity information, wherein:
the second lane change region is smaller than the first lane change region, in a range where a distance to a branching position leading to a destination is less than a threshold value.
